(19) United States
(12) Patent Application Publication
(10) Pub. No.: US 2010/0151883 A1
(43) Pub. Date: Jun. 17, 2010

(54) Method and System for Notifying the Presence of Contacts in a Vicinity of a User

(75) Inventor: Aravind Soundararajan, Bangalore (IN)

Correspondence Address: Motorola, Inc.;Law Department, 1303 East Algonquin Road, 3rd Floor, Schaumburg, IL, 60196, US

(73) Assignee: MOTOROLA, INC., Schaumburg, IL (US)

(21) Appl. No.: 12/713,208

(22) Filed: Feb. 26, 2010

(30) Foreign Application Priority Data
Aug. 30, 2007 (IN) 1843/DEL/2007
Aug. 27, 2008 (US) PCT/US08/74384

(51) Int. Cl. H04W 24/00

(52) U.S. Cl. 455/456.1

(57) ABSTRACT

A method and system for notifying a user of an electronic device of the entrance of one or more contacts of the user within an area of interest is provided. The electronic device is present in a network of a plurality of electronic devices. The method includes, tracking the location of the one or more contacts based on the location of the one or more electronic devices connected to the network. The one or more electronic devices are associated with the one or more contacts. Further, the method includes sending a notification of the entrance of each of the one or more contacts in the area of interest to the user.

### FIELD OF THE INVENTION

The present invention relates, in general, to the field of communication networks, and more specifically, to a method and system for providing notification in communication networks.

### BACKGROUND OF THE INVENTION

Communication networks have become an integral part of the present day world. Advancements in communication networks have accelerated the process of communication among humans. Examples of communication networks include wired and wireless networks such as mobile, computer and telecommunications networks. All such networks have become an integral part of contemporary communication, providing users with a fast and reliable means of interaction. Examples of communication devices in such networks include, but are not limited to, mobile phones, computers and set-top boxes. Communication devices such as mobile phones, computers, set-top boxes, and the like, provide facilities that enable a person to connect to another person, who is located at any place utilizing a combination of the various communication methods available. E-mail, Short Message Service, Mobile calling, Instant Messaging (IM) and Audio Messaging are some important communication methods that have changed the way of human communication.

The various functions of communication devices enable a user to connect to any other communication device in the network. Today, communication is so dependent on these communication devices that users' locations are identified, based on the location of a communication devices used by them. Further, with the advent of new communication methods, the physical addresses of users have been replaced by their electronic addresses. The various forms of electronic address of a user include, but are not limited to, an E-mail address, a mobile phone number, an Internet Protocol (IP) address and the like. A user needs these address details to access or connect to a contact. The details are generally stored with the service provider of the communication network, in the case of an E-mail address, or at the communication device, in the case of mobile phone numbers. The service providers of a communication network include, but are not limited to, Internet Service Providers (ISPs), E-mail web portals, chat and messaging web portals and Multi-Service Operators (MSO) and mobile phone service providers.

Locating a user for communication, based on address details of his/her communication devices, eliminates the need to locate the user physically. That is, the detail of actual physical location of user is not required for communication with the user. As the user location is based on the communication devices used by the user, the variability in the location of the device makes the location of the users mobile. The use of address details, such as E-mail address, mobile phone number, etc., has eliminated the necessity of knowing the physical location of the user of the communication device. Hence, for a user of communication device trying to connect to one of his personal contacts, the physical location of the contact can be hidden. However, the physical location of a user's contact may be required by the user. A typical scenario of this requirement is encountered when a user and his contact are physically located in vicinity but none of them has the information about the presence of the other in the vicinity. A user may require these details when approaching the physical location of his/her contacts or vice-versa.

A user may utilize a variety of tracking methods to find the location of his/her contact, so as to check the presence of the contact in vicinity. But this requires a great deal of effort on the part of the user. Further, the user may only require the information pertaining to the entrance of the contact in vicinity, rather than complete details of the physical location

Currently available systems provide details of the location of contacts of the user in a specific geographic area of a user. But, current systems require the user and the contacts to be in communication link using their mobile phones. Thus limiting the availability of information about the location of the contacts only when the communication link is established. Further, the current system requires the user to send a request to a service provider in order to procure information about the locations of the contacts. Also, the available system is limiting to mobile communication networks. In general, the user would require notification only about the contacts that are entering the geographic area rather than all the contacts in the area as provided by the available system.

In light of the above discussion there is a need for a system and method that tracks the physical locations of a user of an electronic device and his/her personal contacts, and automatically informs the user about the entrance of the contacts in the vicinity. Further, there is a need for notifying the user when the contacts are not in communication link with the user. Also, there is need for a method and system that is applicable when the user and the contacts utilize different electronic devices, such as computational device, set-top box etc.

### BRIEF DESCRIPTION OF FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary network where various embodiments of the present invention can be practiced;

FIG. 2 is a flowchart illustrating a method for notifying a user of an electronic device of the entrance of one or more contacts of the user within an area of interest, in accordance with an embodiment of the invention;

FIGS. 3 and 4 illustrates a flowchart describing the steps of the method of notifying a user of an electronic device of the entrance of one or more contacts of the user within an area of interest, in accordance with another embodiment of the invention; and

FIG. 5 illustrates a network with a device for notifying a user of an electronic device of the entrance of one or more contacts of the user within an area of interest, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for notifying a user about the presence of one or more contacts of the user in vicinity, in accordance with various embodiments of the present invention, it should be observed that the present invention resides primarily in combinations of method steps related to notifying a user of the entrance of a contact in an area of interest. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising”, or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

For an embodiment, a method for notifying a user of an electronic device of the entrance of one or more contacts of the user within an area of interest is provided. The electronic device is present in a network of plurality of electronic devices. The method includes tracking the location of each of the one or more contacts based on the location of the one or more electronic devices associated with the one or more contacts in the network. Further, the method includes sending the notification of the entrance of each of the one or more contacts in the area of interest to the user.

For another embodiment, a device for notifying a user of an electronic device of the entrance of the one or more contacts of the user within an area of interest is provided. The electronic device is present in a network of plurality of electronic devices. The device includes a tracker module that tracks the location of each of the one or more contacts by locating one or more electronic devices associated with the one or more contacts in the network. Further, the device includes a notification module that sends the notification of the entrance of each of the one or more contacts in the area of interest to the user.

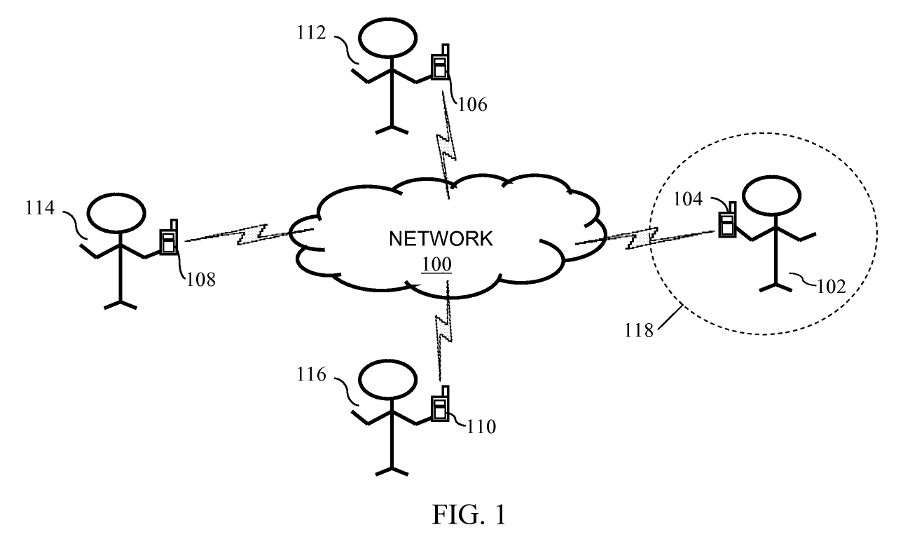

FIG. 1 illustrates an exemplary network 100, wherein various embodiments of the invention can be practiced. The network 100 can be a wired network, a wireless network, or a combination therein. Examples of the network 100 include, but are not limited to, a Local Area Network (LAN), a Wide Area Network (WAN), the Internet, a mobile network and a cable network. A user 102 utilizes an electronic device 104 that is part of a plurality of electronic devices forming the network 100. The network 100 includes electronic devices 104, 106, 108 and 110. Examples of electronic devices 104, 106, 108 and 110 include computational devices, mobile devices and set-top boxes. The user 102 of the electronic device 104 has one or more contacts 112, 114 and 116. The contacts 112, 114 and 116 utilize electronic devices 106, 108 and 110, respectively. An area of interest 118 is defined by a service provider, based on the location of the user 102. Examples of a service provider include, but are not limited to, an Internet Service Provider (ISP), a Mobile Service Provider, a web-based portal, and a Multi-Service Operator (MSO). According to the invention, the service provider identifies the area of interest, based on the location of the user 102. Further, the service provider tracks the location of the contacts 112, 114 and 116. For, tracking the location of the contacts 112, 114 and 116 the service provider does not require the user 102 and the contacts 112, 114 and 116 be in communication link with each other using their electronic devices. The service provider further notifies the user 102 about the entrance of each of the contacts 112, 114 and 116 in the area of interest 118. The notification is sent to the user 102 automatically. In one embodiment, the service provider is a network service provider of the network 100. In one example, if the network 100 is a network of a plurality of mobile devices, the service provider identifies the area of interest 118, based on the location of the mobile device 104 of the user 102. The area of interest 118 can be the area in the vicinity of the user. Exemplary definitions of the area of interest 118 can be area related to Zone Improvement Plan (ZIP) code of the location of the user 102, PIN Code of user 102, city of the user 102, state of the user 102 and country of the user 102. According to the present invention, the user 102 is notified about the entrance of the contacts 112, 114 and 116 in the area of interest 118.

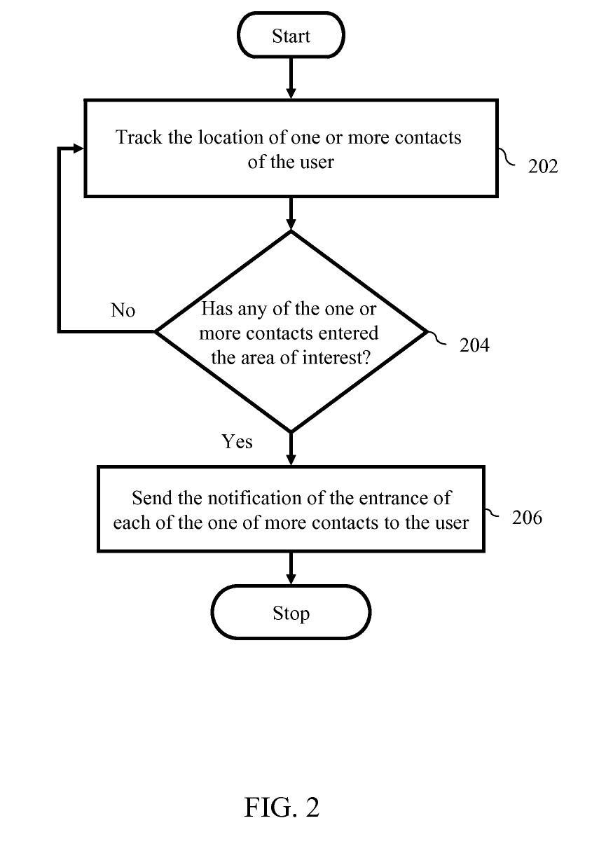

FIG. 2 illustrates a flowchart describing the steps of the method of notifying the user 102 of the electronic device 104 of the entrance of the contacts 112, 114 and 116 of the user within the area of interest 118, in accordance with an embodiment of the invention. To explain the method, references are made to FIG. 1, but should be apparent to a person, who is ordinarily skilled in the art, that the method can be practiced on conjunction with any suitable embodiment of the present invention. At step 202, the location of each of the contacts 112, 114 and 116 of the user 102 is tracked. For tracking the location of the contacts 112, 114 and 116, the electronic devices 106, 108 and 110 associated with them are tracked. The locations of the electronic devices 106, 108 and 110 are identified, based on an identification of one or more of the IP addresses, the global position of the electronic devices 106, 108 and 110, and their registration at a Multi-Service Operator.

At step 204, it is determined whether any of the contacts 112, 114 and 116 have entered the area of interest 118. If it is determined at step 204 that none of the contacts 112, 114 and 116 have entered the area of interest 118, the step 202 of tracking the location of the contacts 112, 114 and 116 is repeated. If it is determined that any of the contacts 112, 114 and 116 have entered the area of interest 118, at step 206 a notification of the entrance of each of the contacts 112, 114 and 116 entering the area of the interest 118 is sent to the user 102. The notification is sent to the user 102 automatically without the user 102 requesting for notification. The methods of sending the notification include, but are not limited to, a Short Message Service (SMS) message, an Instant Message (IM), an E-mail message, an audio message, a text message, a Multi-media Message Service (MMS) message and a visual display message.

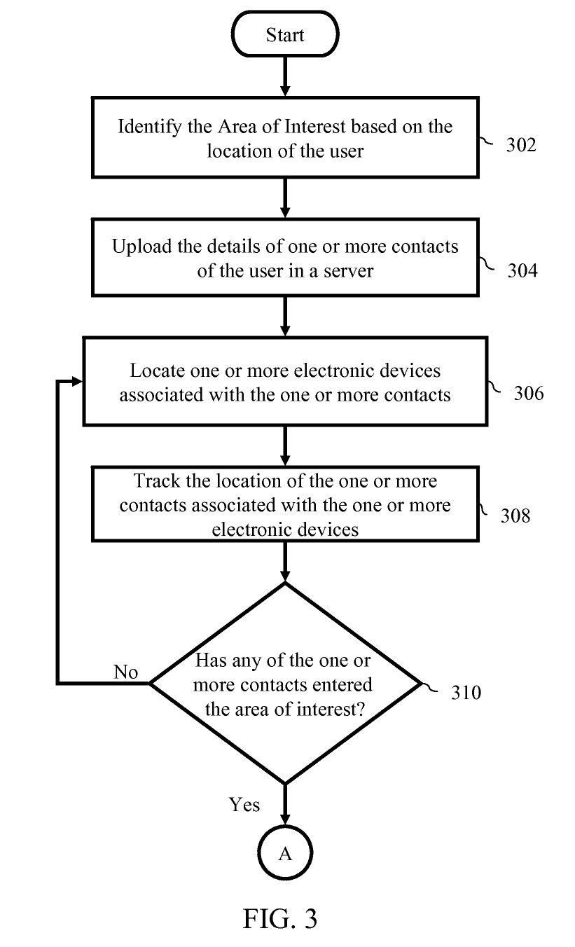

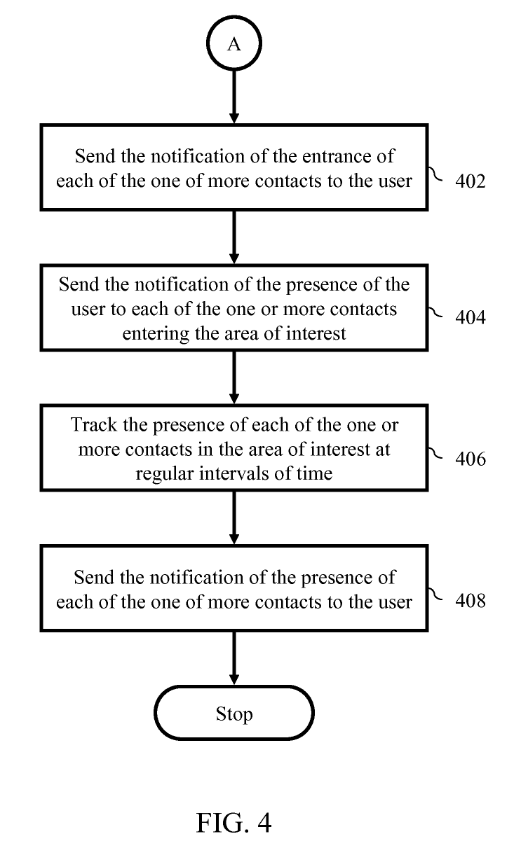

FIGS. 3 and 4 illustrates a flowchart describing the steps of the method of notifying the user 102 of the electronic device 104 of the entrance of the contacts 112, 114 and 116 of the user within the area of interest 118, in accordance with another embodiment of the invention. To explain the method, references will be made to FIG. 1, however it will be apparent to a person ordinarily skilled in the art that the method can be practiced in conjunction with any suitable embodiment of the present invention. At step 302, the area of interest 118 is identified, based on the location of the user 102. The area of interest 118 can be identified based on the ZIP code of location of the user 102, the city of the user 102, the state of the user 102, the country of the user 102 or any other location parameter of the user 102. Other parameters may include, but are not limited to, region utilizing same server as that of the user 102, region utilizing same mobile tower as that of the user 102, region utilizing same Multi Service Operator as that of the user 102, and the like. In an embodiment, the user 102 can define the area of interest 118. The user 102 may wish to define the area of interest 118, apart from his/her location, based on his/her interests or requirements. For instance, while traveling, the user 102 may define the area of interest 118, based on his/her destination location. Once the area of interest 118 is defined, step 304 is performed.

At step 304, details pertaining to the contacts 112, 114 and 116 are uploaded at a server of the service provider by the user 102. According to the invention, the service provider stores the details pertaining to the contacts 112, 114 and 116. Consequently, the service provider tracks the location of the contacts 112, 114 and 116, based on the stored details, and notifies the user 102 of the entrance of the contacts 112, 114 and 116. The details of the contacts 112, 114 and 116 can be a mobile number, an E-mail address. Other examples of the details of the contacts 112, 114, and 116 can be login identification details of the contacts 112, 114 and 116 for the messaging service providers, for the set-top box and for a web portal and, a combination therein. At step 306, the electronic devices 106, 108 and 110 associated with the contacts 112, 114 and 116 are located. The location of the electronic devices 106, 108 and 110 is identified based on one or more of the Internet Protocol address, the global position, the registration at a Multi-Service operator of the electronic devices 106, 108 and 110. Locating the electronic devices 106, 108 and 110 does not require communication link with the electronic device 104 of the user 102. Once the locations of the electronic devices 106, 108 and 110 are known, the locations of the contacts 112, 114 and 116 associated with the electronic devices 106, 108 and 110 are tracked at step 308. At step 310, it is determined whether any of the contacts 112, 114 and 116 has entered the area of interest 118, based on the tracked location of the contacts 112, 114 and 116. In one example, if the tracked location of any of the contacts 112, 114 and 116 lies within the area of interest 118 then it is confirmed that the contacts 112, 114 and 116 have entered the area of interest 118. In another example, steps 306-310 are repeated if the tracked location of none of the contacts 112, 114 and 116 lies within the area of interest 118.

In an embodiment, if it is determined that any of the contacts 112, 114 and 116 has entered the area of interest 118, then at step 402 a notification is sent to the user 102 about the entrance of each of the contacts 112, 114 and 116 that has entered the area of interest 118. For example, if the contact 112 has entered the area of interest 118, a notification is sent to the user 102 of the entrance of the contact 112 in the area of interest 118. At step 404, a notification is sent to each of the contacts 112, 114 and 116 that have entered the area of interest 118 about the presence of the user 102 in the area of interest 118. A notification is sent to the contact 112 about the presence of the user 102 in the area of interest 118 when the contact 112 has entered the area of interest 118. The type of messages that can be sent as notification include, but are not limited to, an SMS message, an Instant Message, an E-mail message, an audio message, a text message, an MMS message and a visual display message. One or all of the above mentioned methods could be used for sending the notification, depending on the electronic device 104 of the user 102 and the electronic devices 106, 108 and 110 used by the contacts 112, 114 and 116. For example, if the electronic devices 102, 106, 108 and 110 are mobile devices then the method of sending notification could be one or all of sending a SMS message, an MMS message, an Audio message, an E-mail message and a text message. Further, the type of messages depend on the various functions of the electronic devices 104, 106, 108 and 110. For instance, if the electronic devices 104, 106, 108 and 110 have E-mail facility then the method of sending notification can be an E-mail message.

At step 406, the presence of each of the one or more contacts 112, 114 and 116 that have entered the area of interest 118 is tracked, at regular intervals of time. The intervals of time can be pre-defined or modified either by the service provider or by the user 102. The tracking of the each of the contacts 112, 114 and 116 that have entered the area of interest 118 is performed based on the location of the electronic devices 106, 108 and 110 used by the contacts 112, 114 and 116. At step 408, a notification is sent to the user 102 about the presence of each of the contacts 112, 114 and 116 in the area of interest 118 to the user 102. In an example, when the contact 112 that has entered the area of interest 118 is present in the area of interest 118 after a pre-defined time interval, a notification is sent to the user 102 about the presence of the contact 112 in the area of interest 118.

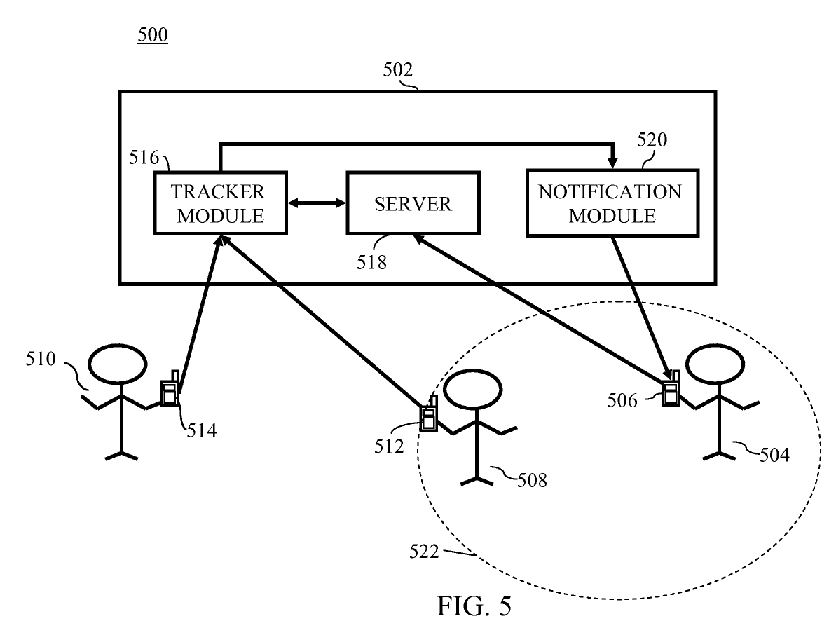

FIG. 5 illustrates a network 500 with a device 502 for notifying a user of an electronic device of the entrance of one or more contacts of the user within an area of interest, in accordance with an embodiment of the present invention. The network 500 is a network of a plurality of electronic devices. Examples of the network 500 include, but are not limited to, a mobile network, the Internet, LAN, WAN, a network of set-top boxes, any wired or wireless network, or a combination therein. FIG. 5 also shows a user 504 uses an electronic device 506 to communicate with one or more contacts 508 and 510. The contacts 508 and 510 are exemplary personal contacts of the user 504, and use the electronic devices 512 and 514, respectively, for communication. The electronic devices 506, 512 and 514 are part of the network 500. The device 502 includes a tracker module 516. The tracker module 516 tracks the location of the one or more contacts 508 and 510 of the user 504. A server 518 in the device 502 stores the details of the contacts 508 and 510 of the user 504. Further, the device 502 includes a notification module 520. The notification module 520 notifies the user 504 of the entrance of the contacts 508 and 510 of the user 504 in an area of interest 522. In one embodiment, the device 502 is located at a network service provider of the network 500.

According to an embodiment of the present invention, the network 500 includes a plurality of mobile devices. In this embodiment, the electronic devices 506, 512 and 514 are mobile devices. The server 518 stores the details of the contacts 508 and 510 of the user 504. In one example, the details of the contacts 508 and 510 are the mobile numbers of the mobile devices 512 and 514. The area of interest 522 is identified, based on the location of the user 504. The tracker module 516 tracks the location of the mobile device 506 of the user 504, and locates the user 504. The tracker module 516 consequently identifies the area of interest 522, based on the location of the user 504. The tracker module 516 also tracks the location of the contacts 508 and 510, based on the details stored in the server 518. This is performed by tracking the location of the mobile devices 512 and 514 of the contacts 508 and 510. Tracking the location of the mobile devices 512 and 514 is performed, based on the global position of the mobile devices 512 and 514, IP of the mobile devices 512 and 514 or from the service provider of the network 500. The tracker module 516 also registers the last known location of the contacts 508 and 510 in the server 518. Whenever there is a change in the location of any of the contacts 508 and 510 to the area of interest 522, the tracker module 516 identifies the change as the entrance of the particular contact in the area of interest 522. In another example, when the location of the contact 508 changes from its location to the area of interest 522, the tracker module 516 identifies the contact 508 as the contact entering the area of interest 522. On identification of the entrance of the contact 508 in the area of interest 522, the tracker module triggers the notification module 520. The notification module 520 then sends a notification to the user 504 about the entrance of the contact 508 in the area of interest 522. The notification of the entrance of the contact 508 is sent to the mobile device 506 of the user 504. The method of sending notification can be, but is not limited to, an SMS message, an MMS message, a visual display message, an audio message, an E-mail message and a text message. In another example, the notification module 520 sends a notification of the presence of the user 504 in the area of interest 522 to the contact 508. Once the contact 508 has entered the area of interest 522, the tracker module 516 tracks the presence of the contact 508 at regular intervals of time in the area of interest 522. Further the notification module 520 sends a notification to the user 504 of the presence of the contact 508 in the area of interest 522 at regular intervals of time

The tracking and notification techniques used in the invention depend on the electronic devices in the network. In another embodiment, the network 500 is a network of a plurality of computational devices. In this embodiment, the electronic devices 506, 512 and 514 are computational devices. The tracker module 516 locates the contacts 508 and 510, based on the location of the computational devices 512 and 514 used by the contacts 508 and 510. The tracker module 516 locates the computational devices 512 and 514 based on the IP address of the computational devices 512 and 514 and the details of the contacts 508 and 510. The details of the contacts 508 and 510 may include E-mail address, login details at an internet service provider, login at a web portal and the like. The details of the contacts 508 and 510 are stored in the server 518. Whenever the contacts 508 and 510 use the computational devices 512 and 514 for checking E-mail messages or for web access, the IP addresses of the computational devices 512 and 514 along with the login details of the contacts 508 and 510 enable the tracker module 516 to find the location of the contacts 508 and 510.

In yet another embodiment of the present invention, the user 504 uses the computational device 506 to access a web portal. In one example, the user 504 utilizes an exemplary web portal www.abcd.com. The web portal www.abcd.com provides E-mail and chat facilities. Further, the contacts 508 and 510 of the user 504 use the same web portal. The tracker module 504 locates the contacts 508 and 510, based on the IP address of the computational devices used by the contacts 508 and 510 to log into the web portal www.abcd.com. In another example, the contact 508 moves into the area of interest 522. Thereafter, the contact 508 logs into the web portal www.abcd.com using the computational device 512. The login details of the contact 508 are stored in the server 518. The tracker module 516 then identifies the contact 508 to have entered the area of interest 522, based on the IP address of the computational device 512 that is present in the area of interest 522. Further, the tracker module 516 triggers the notification module 520 to send notification of the entrance of the contact 508 to the user 504. The notification module 520 then sends an E-mail message to the E-mail address of the user 504 at www.abcd.com. After a pre-defined interval of time, the tracker module 516 again tracks the location of the contact 508, based on the IP address of the computational device 512 used for the last known login by the contact 508 in the portal www.abcd.com. If it is found that the contact 508 is still located in the area of interest 522, then the notification module 520 sends an E-mail message to the E-mail address of the user 504 at www.abcd.com informing the user 504 that the contact 508 is still present in the area of interest 522.

In this network of computational devices, the method of notification used by the notification module 520 can be, but is not limited to, an E-mail message, an instant message, and the like. For example, if the user 504 and his/her contacts 508 and 510 use the Instant Messaging (IM) service or chat service of the web portal www.abcd.com, the method of notification could be sending an instant message to the user 504.

In yet another embodiment, the network is a plurality of Set-top boxes, and the electronic devices 506, 512 and 514 are also Set-top boxes. In this network, the tracker module 516 of the device 502 tracks the location of the contacts 508 and 510, based on their last known registration at a Multi-Service Operator using the Set-top boxes 512 and 514. Registration details of the contacts 508 and 510 are stored in the server 518. The tracker module 516 identifies the registration at the Multi-Service Operator by the contacts 508 and 510 using the registration details stored in the sever 518. In an example, the contact 508 enters the area of interest 522 and registers at the Multi-Service Operator using the Set-Top box 512 that is present in the area of interest 522. The tracker module 516 then identifies the contact 508 as a contact entering the area of interest 522. The tracker module 516 consequently triggers the notification module 520 to send a notification message of entrance of the contact 508 to the user 504. Further, the method of sending notification used by the notification module 520 to notify the user 504 can be, but is not limited to, audio message and visual display on the Set-top box 506 of the user 504.

The user 504 and his/her contacts 508 and 510 can use different electronic devices in the network 500. The tracker module 516 and the notification module 520 accordingly adjust themselves to the requirement of tracking or sending notification to the different electronic devices used by the user 504 and the contacts 508 and 510. In an example, the user 504 uses the computational device 506 and the contacts 508 and 510 use the mobile devices 512 and 514. The contact 508 with a mobile device 512 enters the area of interest 522 of the user 504. The tracker module 516 tracks the location the contact 508 based on the global positioning of the mobile device 512 of the contact 508. If the contact 508 enters the area of interest 522, the tracker module 516 then identifies the entrance of the contact 508 in the area of interest 522. On identifying the entrance of the contact 508 in the area of interest 522 the tracker module 516 triggers the notification module 520 to send a notification of entrance of the contact 508 to the user 504. The notification module 520 then sends a notification E-mail message to the E-mail address of the user 504 at www.abcd.com. Thereafter, the user 504 checks E-mail messages using the computational device 506.

Various embodiments of the method and system for notifying the presence of contacts in vicinity of a user are within the scope of the present invention. The present invention describes identifying the location of the area of interest, depending upon the location of the user. Further, the invention describes tracking of the contacts of the user. The invention also describes method and system for automatically notifying the user about the entrance of the contacts of the user in the area of interest, based on the tracking of the contacts of the user.

It will be appreciated that the method and system for notifying the presence of contacts in vicinity of a user, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. As such, these functions may be interpreted as steps of a method for automatic notification of the presence of contacts in vicinity. Alternatively, some or all the functions can be implemented by a state machine that has no stored program instructions, or in one or more application-specific integrated circuits (ASICs), in which each function, or some combinations of certain of the functions, are implemented as custom logic. Of course, a combination of the two approaches can also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made, without departing from the scope of the present invention, as set forth in the claims. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

We claim:

1. A method for notifying a user of an electronic device of the entrance of one or more contacts of the user within an area of interest, the electronic device being present in a network of a plurality of electronic devices, the method comprising:
tracking the location of each of the one or more contacts based on the location of one or more electronic devices in the network, wherein the one or more electronic devices are associated with the one or more contacts; and
sending the notification of the entrance of each of the one or more contacts in the area of interest to the user.

2. The method as recited in claim 1 wherein, the area of interest is identified based on the location of the user.

3. The method as recited in claim 1 further comprising uploading the location details of each of the one or more contacts in a server.

4. The method as recited in claim 1, wherein the plurality of electronic devices is at least one of a plurality of mobile devices, a plurality of computational devices and a plurality of set-top boxes.

5. The method as recited in claim 1, wherein locating the one or more electronic devices is performed based on at least one of an Internet Protocol address, registration at a Multi-Service Operator and global position of the one or more electronic devices.

6. The method as recited in claim 1, wherein sending the notification to the user is performed by at least one of sending a Short Messaging Service message, sending an audio message, sending an E-mail message, sending an instant message and displaying the notification on the electronic device.

7. The method as recited in claim 1 further comprising sending the notification of the presence of the user in the area of interest to each of the one or more contacts entering the area of interest.

8. The method as recited in claim 1 further comprising tracking the presence of each of the one or more contacts in the area of interest at regular intervals of time.

9. The method as recited in claim 8 further comprising sending the notification of the presence of each of the one or more contacts in the area of interest to the user.

10. A device for notifying a user of an electronic device of the entrance of one or more contacts of the user within an area of interest, the electronic device being part of a network of a plurality of electronic devices, the device comprising:
a tracker module, the tracker module tracks the location of each of the one or more contacts by locating one or more electronic devices in the network, wherein the one or more electronic devices are associated with the one or more contacts; and
a notification module, the notification module sends the notification of the entrance of each of the one or more contacts in the area of interest to the user.

11. The device as recited in claim 10, wherein the tracker module identifies the area of interest based on the location of the user.

12. The device as recited in claim 10 further comprising a server, wherein the server stores location details of each of the one or more contacts.

13. The device as recited in claim 10, wherein the plurality of electronic devices is at least one of a plurality of mobile devices, a plurality of computational devices and a plurality of set-top boxes.

14. The device as recited in claim 10, wherein the tracker module locates the one or more electronic devices by at least one of registering an Internet Protocol address, identifying the registration at a Multi-Service Operator and registering the global position of the one or more electronic devices.

15. The device as recited in claim 10, wherein the notification module sends the notification by at least one of sending a Short Message Service message, sending an audio message, sending an E-mail message, sending an instant message and displaying the notification on the electronic device.

16. The device as recited in claim 10, wherein the notification module sends the notification of the presence of the user in the area of interest to each of the one or more contacts entering the area of interest.

17. The device as recited in claim 10, wherein the tracker module tracks the presence of each of the one or more contacts in the area of interest at regular intervals of time.

18. The device as recited in claim 17, wherein the notification module sends the notification of the presence of each of the one or more contacts in the area of interest to the user.
